(19) United States
(12) Patent Application Publication
(10) Pub. No.: US 2002/0128962 A1
(43) Pub. Date: Sep. 12, 2002

(54) Card management system and method therefore

(76) Inventor: Sheldon Kasower, Canoga Park, CA (US)

Correspondence Address: ALAN R. DAVIS, 14619 LA MAIDA STREET, SHERMAN OAKS, CA, 91403, US

(21) Appl. No.: 09/846,616

(22) Filed: May 1, 2001

Related U.S. Application Data
(60) Provisional application No. 60/201,994, filed on May 4, 2000.

(51) Int. Cl. G06F 17/60

(52) U.S. Cl. 705/38

(57) ABSTRACT

The invention is a method and system for on-line card management, wherein the card is issued to a card user 39 by an issuing organization 46. The card user 39 interfaces with a card management organization 44 via the card user's own computer 40 through the Internet system 38 to a computer system 42 within the management organization 44. The computer system 42 includes a computer program 44 that processes the request concerning the card(s) and the card issuer 46 is informed of the card user's 39 request via the Internet system 38. The computer program thereafter informs the card user 39 that the card issuer 46 has been informed.

### Related Applications

This application is a continuation-in-part to Applicant's co-pending provisional application, Ser. No. 60/201,994, filed May 4, 2000.

### FIELD OF THE INVENTION

The present invention generally relates to a credit card management system, and more particularly to an on-line card management system accessible via a computer network, such as the Internet.

### BACKGROUND OF THE INVENTION

The explosion in the use of multiple credit and charge cards in the late 1960s created the need for card protection. At the time, this need could be efficiently filled with 1960s enabling technology (e.g., minicomputer) and efficient communications (e.g., toll-free calls, telex, etc.). The demand for a “one call does it all” service for communicating with multiple card issuers for the purpose of limiting liability, reporting lost or stolen cards or changes of address made sales easy. Today, there has been a great explosion in the number and type of cards per household. Such cards include credit cards, charge cards, debit cards, ID cards, medical insurance cards, library cards, automobile club cards, discount cards, and membership cards.

The principle prior art method of reporting a change of address, requesting a new card, notification of a billing dispute, requesting a copy of a bill, reporting a change in martial status, reporting a lost or stolen card, or requesting an increase in credit line, required a phone call or written notification to the card issuer. This often required the cardholder to spend a substantial amount of time thereafter on “hold” until a service representative became available or navigating through an automated voice response system. The cardholder could also subscribe to a lost or stolen card service. Here the cardholder was required to submit a list of the cards and the associated data thereto by mail. Thus a significant amount of time could pass before protection was obtained. If a card was lost or stolen, the cardholder was required to telephone the service. Of course, any change in a card or the addition of a card required an additional letter.

Thus it is a primary object of the invention to provide a card management method and system that harnesses modern communications and information technology to each and every card that one might carry.

It is another primary object of the invention to provide a card management method and system to extend card protection services to meet current cardholder expectations.

It is a further object of the invention to provide a card management method and system wherein the cardholder, can conduct a multitude of transactions in a single connection to the Internet.

It is another object of the invention to provide a card management method and system to provide on-line card registration. It is another object of the invention to provide a card management method and system that can instantly notify the card issuer of a lost or stolen card.

It is another object of the invention to provide a card management method and system that can instantly notify the card issuer of a change in address of the cardholder.

It is another object of the invention to provide a card management method and system that allows the cardholder to request a replacement card or an additional card for another individual.

It is another object of the invention to provide a card management method and system that allows automated notification to the card issuer of a billing dispute.

It is another object of the invention to provide a card management method and system to allow the cardholder to request a duplicate bill or details on a particular charge.

It is another object of the invention to provide a card management method and system to allow the cardholder to notify the card issuer of a change in marital status.

It is another object of the invention to provide a card management method and system to allow the cardholder to request an increase in his or her line of credit.

### SUMMARY OF THE INVENTION

It should be appreciated that the card management system of the present invention is suitable for use in connection with a wide variety of cards, including but not limited to: credit cards, charge cards, ATM/debit cards, check cashing cards, identification (ID) cards, medical insurance cards, library cards, automobile club cards, car rental cards, discount cards, association/club membership cards, access cards (card keys), driver's license cards, school ID cards, health club cards. Moreover, it is further contemplated that the card management system of the present invention may also be suitably used in connection with other products, such as securities (e.g., stocks and bonds) and insurance policies, where similar information is stored, modified, and exchanged.

In detail, the method includes the steps of: 1) accessing a card management computer system in a computer network; 2) selecting at least one of a plurality of card management services provided by the computer system; 3) inputting data associated with the selected card management service; and 4) providing the associated data to the issuing organization.

In addition, the services include registering at least one card by inputting associated card data, change of address, request for a new card, notification of a billing dispute, request for a copy of a bill, a change in martial status or name change and a request for an increase in credit line. Furthermore, a record of the associated data is maintained as well as providing a confirmation that the issuing organization has been contacted and provided the associated card data.

The system in a broad sense is an on-line card management system, wherein the card is issued by a issuing organization, includes: a computer system accessible via a computer network, the computer system including: a selection program for selecting at least one of a plurality of card management services; an input program for inputting data associated with the selected card management service; and a program providing the data associated with a selected card management services to the issuing organization.

The on-line card management system card management services includes registering at least one card by inputting associated card data, a change of address, request for a new card, notification of a billing dispute, request for a copy of a bill, a change in martial status, reporting a lost or stolen card, and a request for an increase in credit line where applicable. Furthermore, the on-line card management system includes a program for maintaining a record of the associated data as well as a program for informing the card user that the card issuing organization has been provided the associated data.

The present invention provides several significant advantages over prior art card management systems. First, pre-registration of cards can be accomplished easily by the cardholder, with fewer hassles, and much less cost. Secondly, the actual process of notification is better and faster since it is completed by the cardholder at his own pace, on his own computer, and without the time consuming hassle of a telephone call. Thirdly, notification can be done more reliably through an internet-based notification “engine,” thus providing better service to the cardholder, and the card issuer.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF FIGURES

FIG. 1 is a simplified schematic of the card management system.

FIG. 2 is a view of the “site entry” screen.

FIG. 3 a simplified view of the “new member registration” screen.

FIG. 4 is a flow chart of the computer program for “new member registration” services.

FIG. 5 is a simplified view of the “registration check” screen.

FIG. 6 is a flow chart of the computer program for “user identification and password check” service”

FIG. 7 is a simplified view of the “logging in” screen.

FIG. 8 is a simplified view of the screen for “selection of member services.”

FIG. 9 is a flow chart of the computer program for “check-in.”

FIG. 10 is a simplified view of the screen for “canceling services.”

FIG. 11 is a flow chart for the computer program to “cancel services.”

FIG. 12 is a simplified view of a screen for “obtaining technical support” services.

FIG. 13 is a flow chart of the computer program for “obtaining technical support” services.

FIG. 14 is a flow chart of the computer program for “logging out.”

FIG. 15 is a view of the screen for “register/editing cards.”

FIG. 16 is a flow chart for a computer program for “adding and registering cards” services.

FIG. 17 is a flow chart for a computer program for “editing and viewing and deleting cards” services.

FIG. 18 is a flow chart for a computer program for “adding cards from unlisted issuers” services.

FIG. 19 is a screen for “requesting a new or replacement cards when the card is already registered.”

FIG. 20 is a flow chart for the computer program for “requesting new or replacement card that is already registered” services.

FIG. 21 is a screen for reporting a lost card.

FIG. 22 is a flow chart for a computer program for “reporting lost cards” services.

FIG. 23 is the flow chart for a computer program for “reporting lost cards to the card issuer.

FIG. 24 is a continuation of the flow chart illustrated in FIG. 23.

FIG. 25 is a continuation of the flow chart illustrated in FIG. 23.

FIG. 26 is a continuation of the flow chart illustrated in FIG. 23.

FIG. 27 is a continuation of the flow chart illustrated in FIG. 23.

FIG. 28 is a flow chart of the card management organization “monitoring procedure for insuring lost cards are reported to the issuer.”

FIG. 29 is the screen for reporting an“address change.”

FIG. 30 is a flow chart for a computer program for “making an address change” services.

FIG. 31 is the screen for reporting a “change in name and or a change in marital status” services.

FIG. 32 is the flow chart for a computer program for making a “name or marital status change” services.

FIG. 33 is the screen for “requesting a credit increase for a credit card.”

FIG. 34 is the flow chart for a computer program for “requesting a credit increase” services.

FIG. 35 is the screen for reporting a “charge dispute” made on a credit card.

FIG. 36 is the screen for “ordering a copy of a statement.”

FIG. 37 is the flow chart for a computer program for “reporting a charge dispute made on a credit card” and “ordering a copy of a statement” services.

### DETAILED DESCRIPTION OF THE PREFERRED EMBODIMENT

Set forth below is an overview of a preferred embodiment of the present invention. It should be appreciated that, while a preferred embodiment of the present invention is described in connection with the Internet, the present invention is suitable for use in connection with other computer networks. Moreover, the card management system of the present invention may be directly accessible, or accessible via a private computer network. In the following discussion of the invention, selected computer screens are used for purposes of illustration, but it will be obvious that additional screens are used, but not disclosed nor need they be for purposes of understanding the invention.

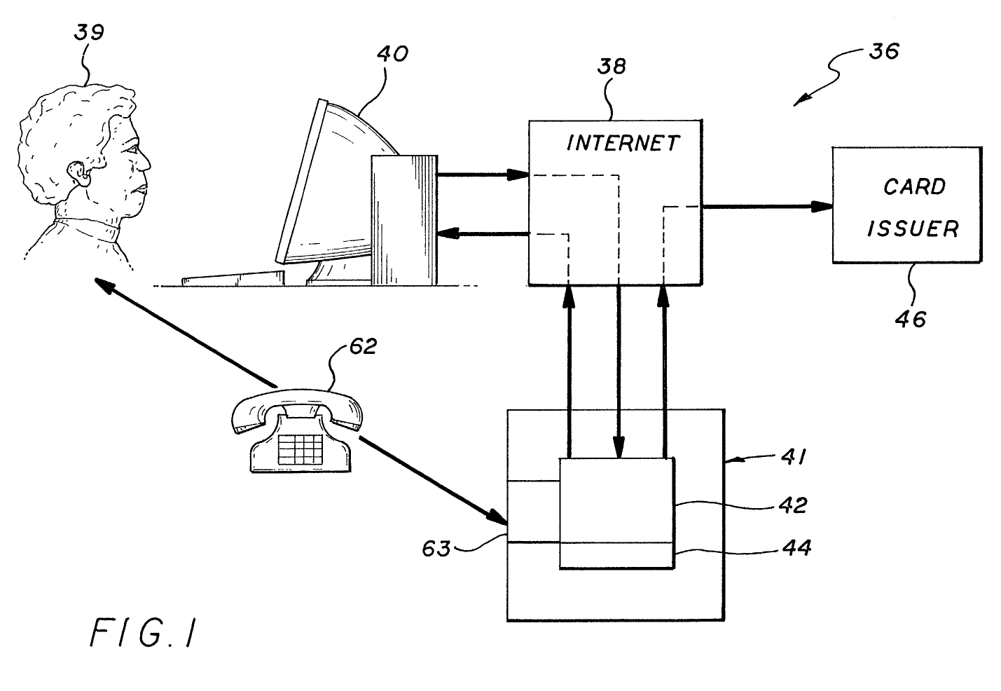

As illustrated FIG. 1, the card management system, generally indicated by numeral 36, uses the Internet system 38 to interface with the individual card holder 39 via the individual's computer 40 and the card management organization 41. The card management organization 41 includes computers 42 having a card management computer program 44 therein which process data concerning the cards and provides associated card data to the card issuer 46 also via the Internet system 38. Provisions are provided for non-internet communication with the card user and the card issuer, as will be subsequently discussed.

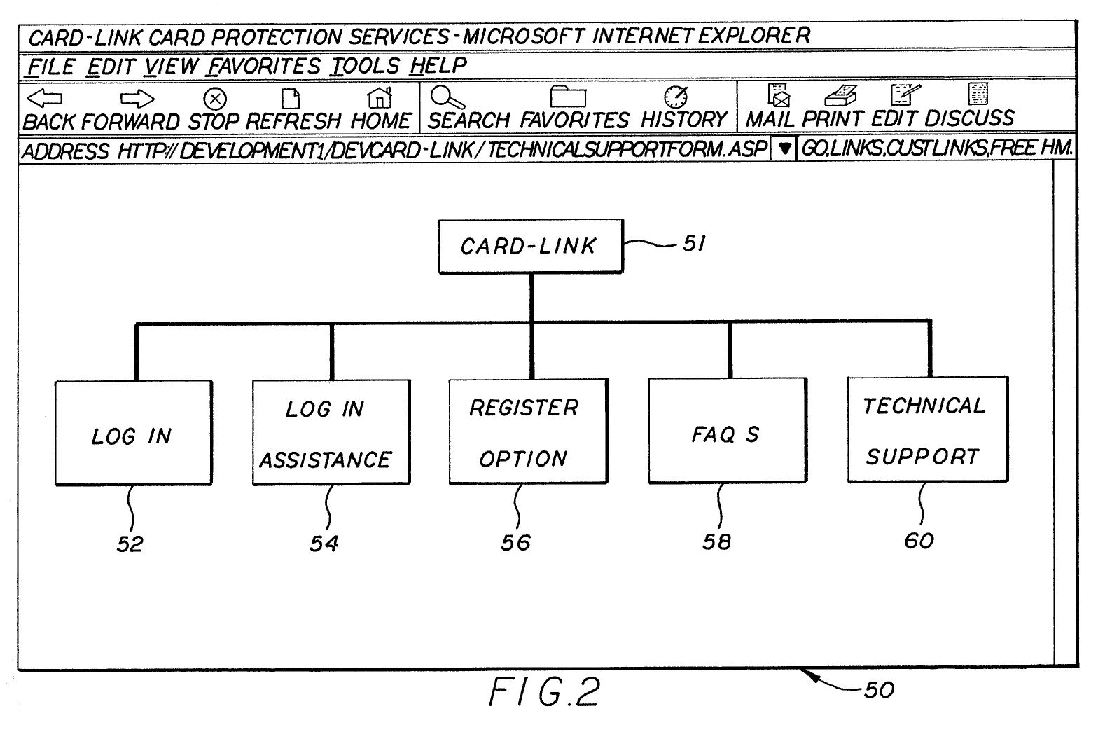

As illustrated in FIG. 2, when the cardholder or user “pulls up” the main screen, generally indicated by numeral 50, it is either generic (if accessed directly) or customized (if accessed via a sponsor). The main screen includes a series of links: a log in option 52 to enter the user ID and password for the purpose of logging in, log in assistance link 54 for the customer who is not sure he is a member, or who has forgotten either his User ID or Password; registering link 56, frequently asked questions link 58 and technical support link 60.

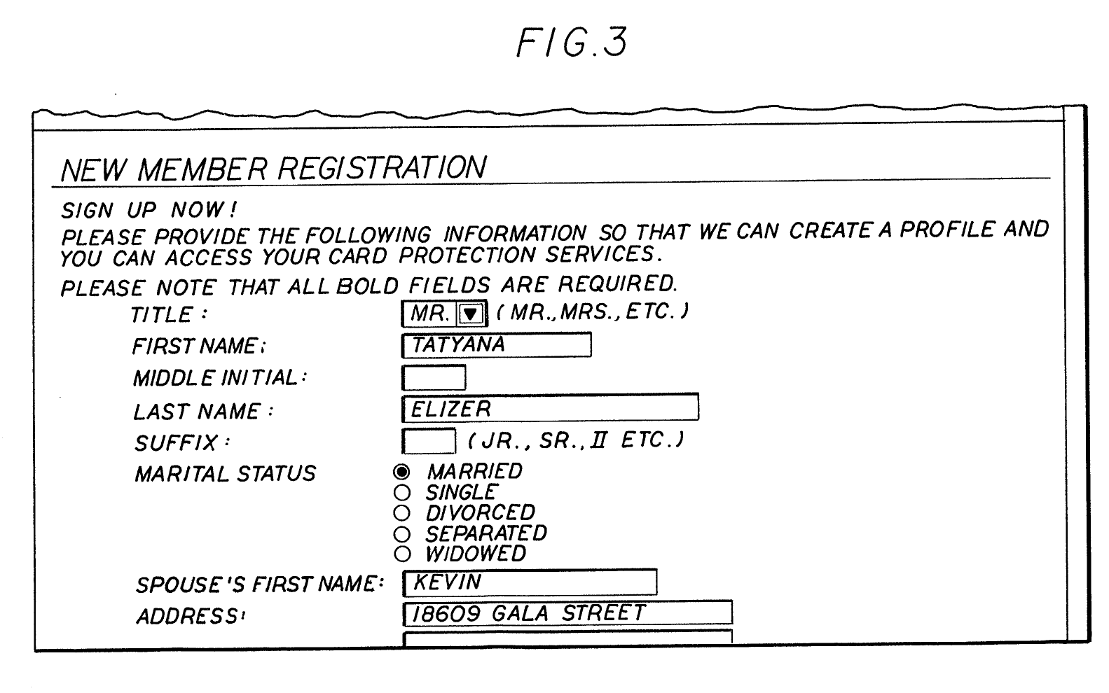

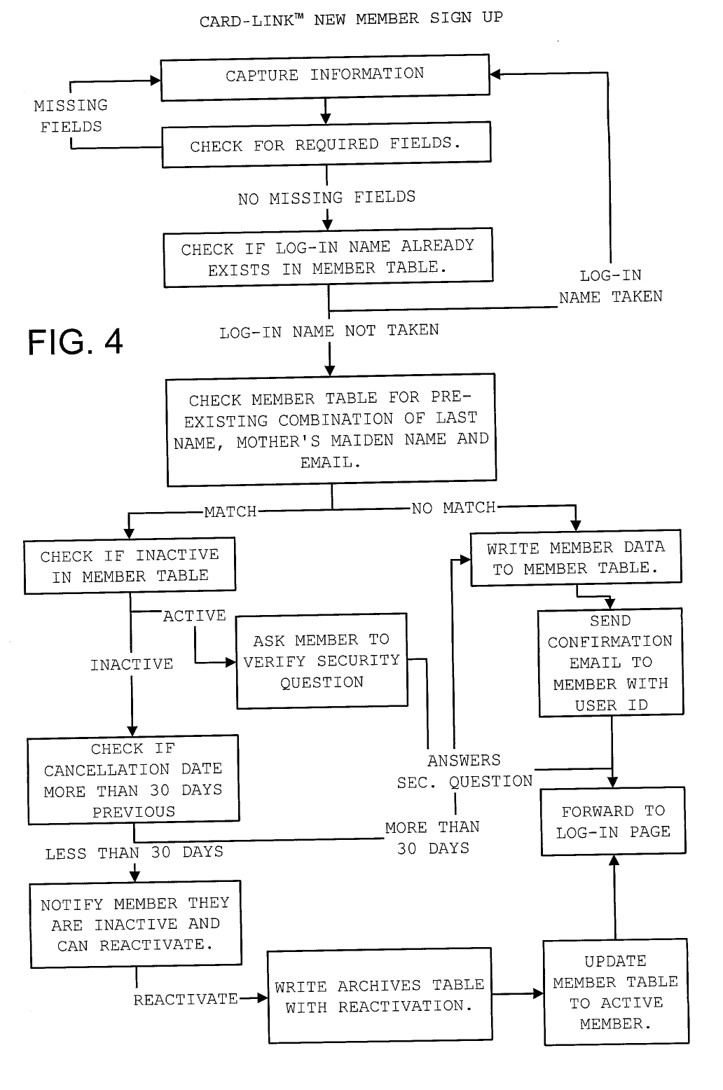

If the cardholder is not a member and wishes to register, the individual may “click” on the Register Option 56 and will pull up the Registration Screen as shown in FIG. 3. The computer program for the registration process is presented in the flow chart as illustrated in FIG. 4. The individual will be guided through the registration process and will be requested to provide the specified information in the flow chart. At the end of the process, the individual will be registered and have a personalized user identification and password. The individual can then return to the main menu screen (FIG. 2).

Upon return to the main menu screen (FIG. 2), the individual may want to learn more about the card management system by clicking on the Frequently Asked Questions Option 58. This will bring the individual to a screen wherein most frequently asked questions are presented with answer. Following are examples:

Q: Why should I register?

A: Managing a wallet full of cards is a major responsibility! Registering takes the hassle out of managing your cards. It's easy to maintain your card list on-line, and communication with a card issuer becomes almost effortless with the click of a mouse.

Q: Which cards may I register?

A: All of your cards! That includes credit and debit cards, ID cards, membership cards, insurance cards . . . virtually any card you carry in your wallet.

Q: Must I pre-register my cards?

A: No. Although it may be more convenient to pre-register your cards, you may register cards at the time service is requested.

Q: What if I register a card you have not heard of?

A: In that event, we will ask you for some basic details about the card issuer when the card is registered. Cards are our business, so we don't expect this to be a common occurrence.

Q: May I register cards of my spouse or other family members?

A: Certainly! A place is provided for you to enter an alternate cardholder name for any card registered.

Q: May I register business cards that go to a different address?

A: Yes. A place is provided for you to enter an alternate address for any card registered.

Q: If I have informed my card issuers directly of a loss or change of address, will they notify you?

A: No. Card issuers will not notify Card-Link of reports or changes you make directly with them.

Q: Will you keep a record of the different times I use your service?

A: Yes. We will keep an archive of your use of the service for a minimum of two years and you can view that service record at any time.

Q: Can my partner or spouse have their own membership?

A: Yes, but they will have to register as a separate member and pay their own fee as defined by your bank.

Q: How quickly will my cards be replaced after I have reported their loss?

A: The re-issue of cards is in the hands of the issuer and whilst they all take immediate notice of the loss reports, the speed at which they send out new cards will vary from 24 hours to 10 days.

Q: How can I get my lost cards replaced more quickly?

A: While we can report all your cards, lost we cannot influence the response of your card issuers. If you need a replacement in a hurry we suggest that, after having reported all your cards, you speak directly to the card issuer from whom you need the urgent card replacement.

Q: How secure is your website?

A: We take security of your data seriously. We use Secure Socket Layers (SSL, the industry standard) and the best software and hardware security solutions available today. All of your personal information—including name, address and card numbers—is encrypted so that information cannot be read as it travels over the Internet. Frankly, your information is more secure on our secure server than it is in a typical office environment.

Q: How do you ensure no one else has access to my information?

A: In addition to having state-of-the-art software and hardware to protect the data registered with us (see previous question), your file is password protected. You alone have control over your password, and can change it as often as you like.

Q: Is there any way I can know for sure my information is encrypted?

A: Your browser will tell you. Both Netscape and Internet Explorer browsers display an icon at the bottom of the screen indicating that you are at a secure site.

Q: How do you notify card issuers?

A: Card issuers are notified via e-mail, fax, telex, phone or letter. Many times one method is preferred by a particular card issuer.

Q: What is the liability for fraudulent use of a credit card?

A: Liability is limited under the Consumer Credit Act to $50. This limit does not apply if the cardholder acts fraudulently or with gross negligence, including disclosure of the cardholder's PIN number.

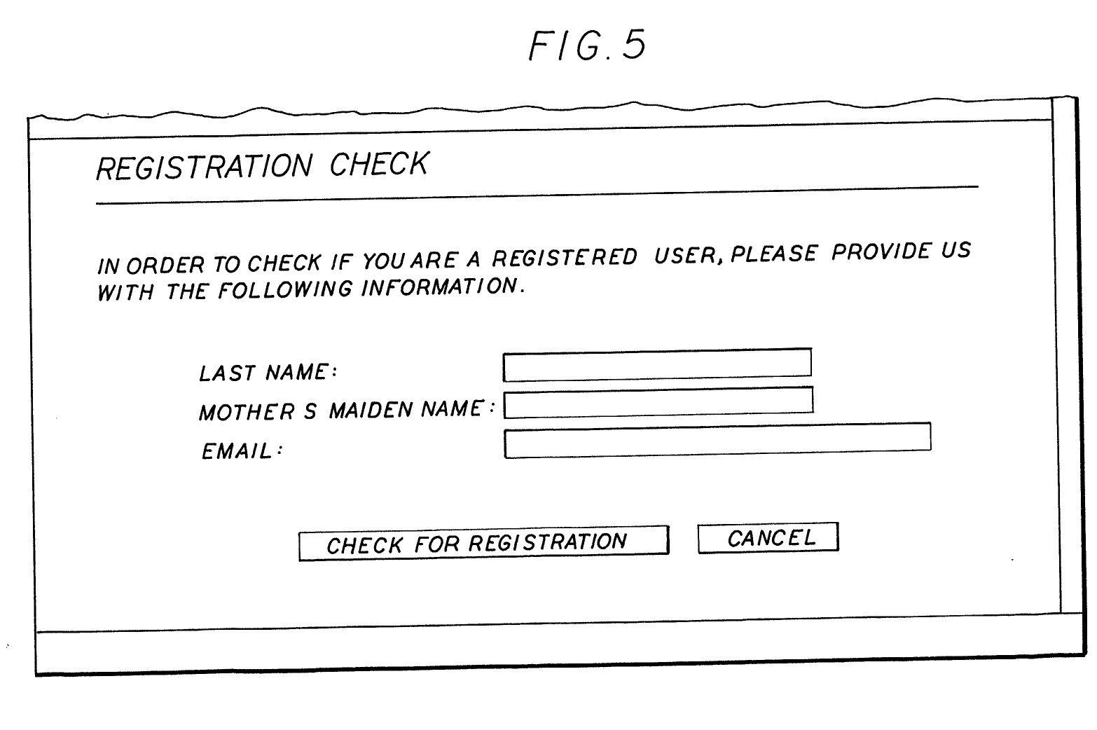

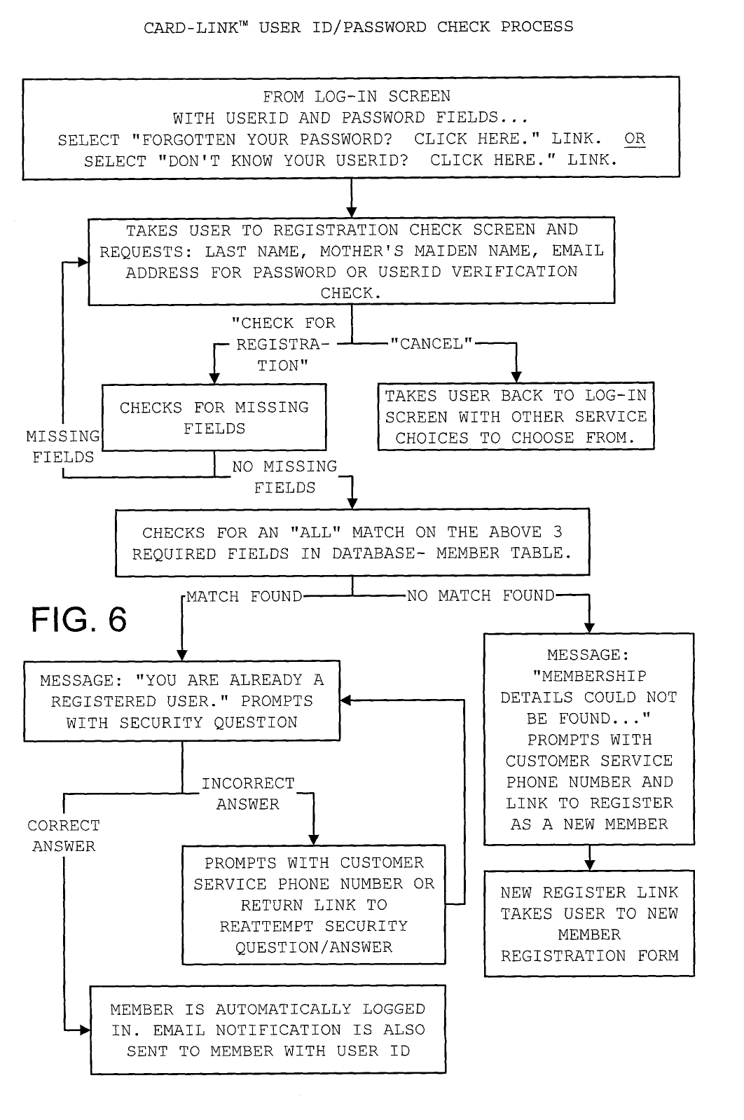

If the individual is not sure he is a registered member, he or she can click on Log In Assistance 54 in FIG. 2, which will bring a separate screen shown in FIG. 5 and will be guided through a check procedure as set forth in the flow chart in FIG. 6. Note that, if at the end of the process the individual is found to already be a member, he or she is brought back to the Main menu (FIG. 2). Upon clicking on the Log in Option 52, the individual will learn whether he or she is already logged in. If not found to be registered, the individual is brought to the Registration Screen (FIG. 3).

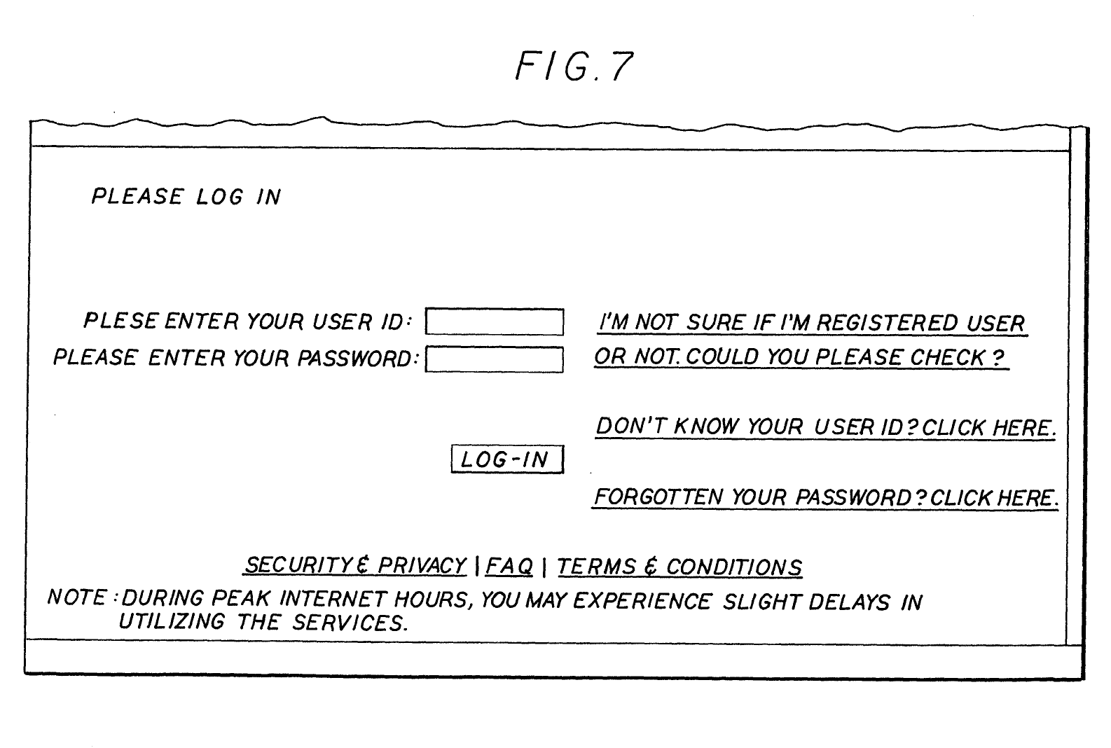

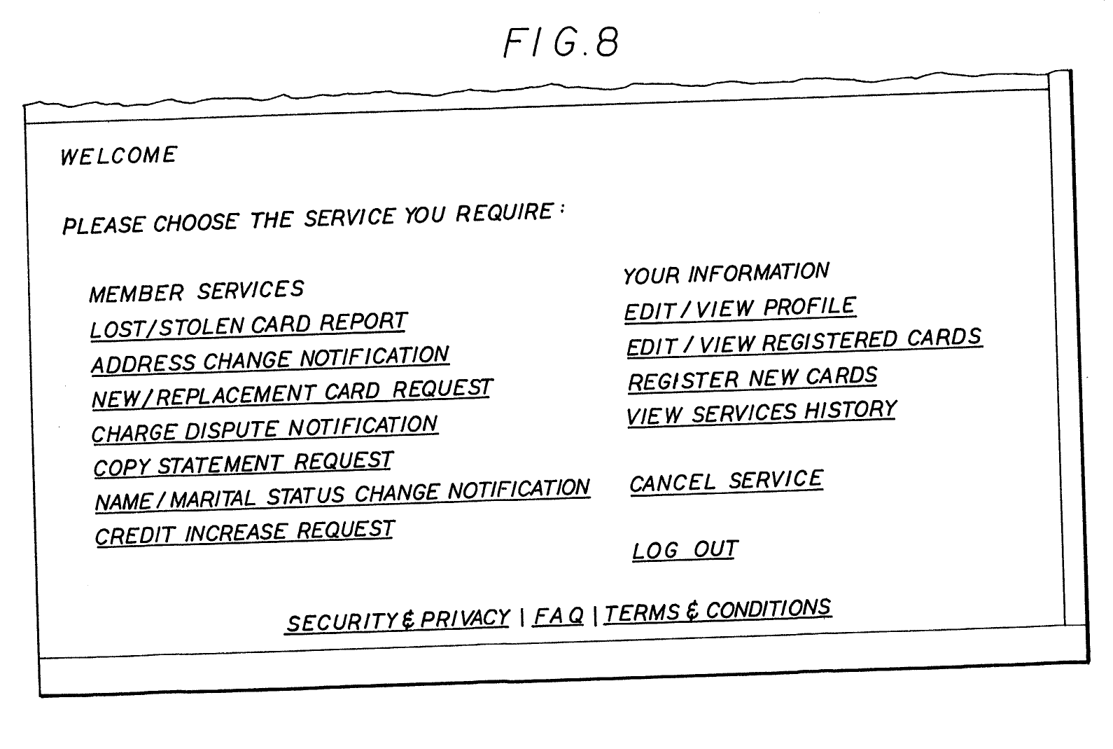

If the individual is already a member or has just become a member and knows the pin number, the individual can click on the Log In Option 52 (FIG. 2) which will bring up the Log in screen as shown in FIG. 7. Upon logging in, the Member Services menu as illustrated in FIG. 8 will appear. This allows the individual to access the services offered:

1. Report Lost/Stolen Card(s)

2. Address Change

3. Request New/Replacement Card(s)

4. Charge Dispute

5. Request Copy of Statement

6. Report Change of Marital Status/Name

7. Request Increased Credit Limit

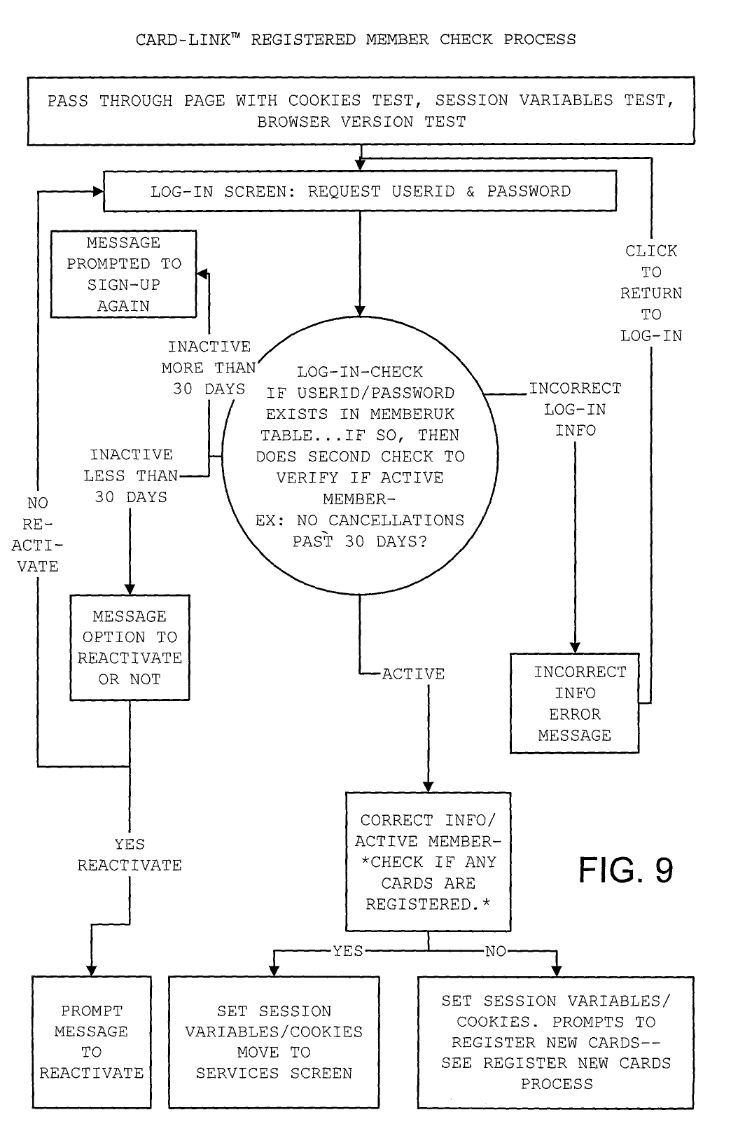

All these steps are illustrated in the computer flow chart illustrated in FIG. 9.

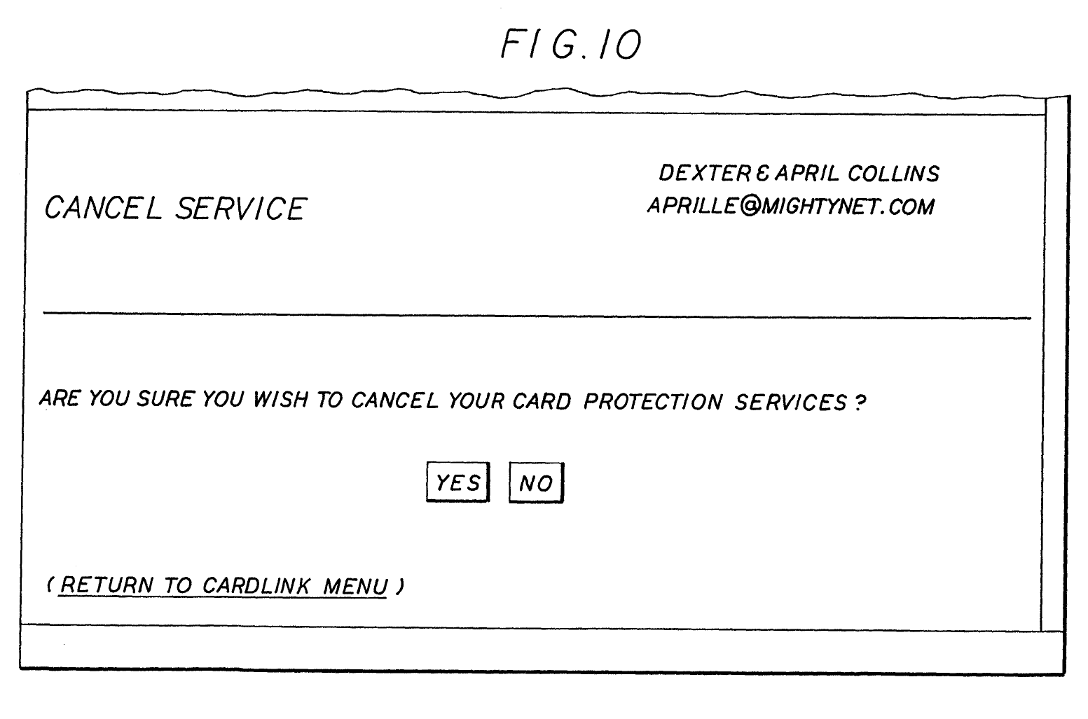

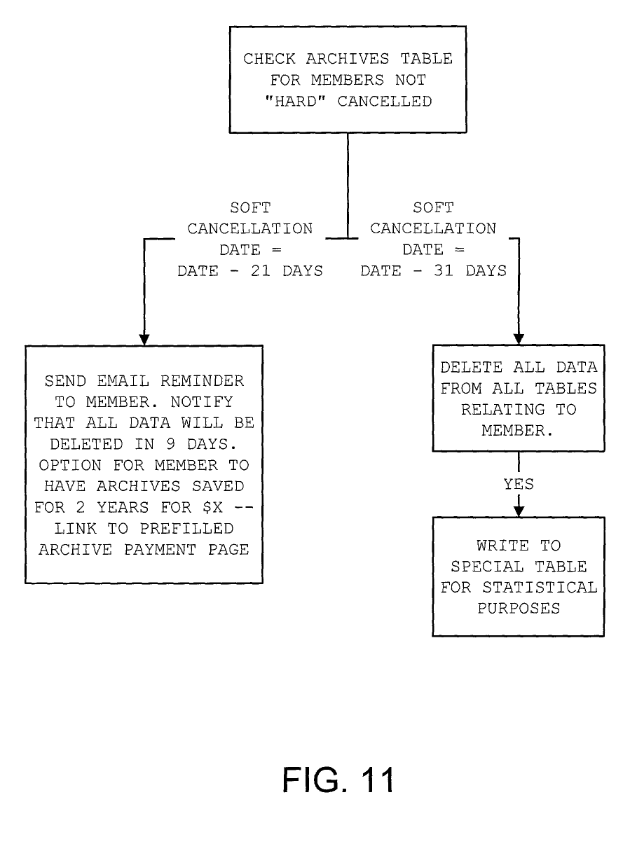

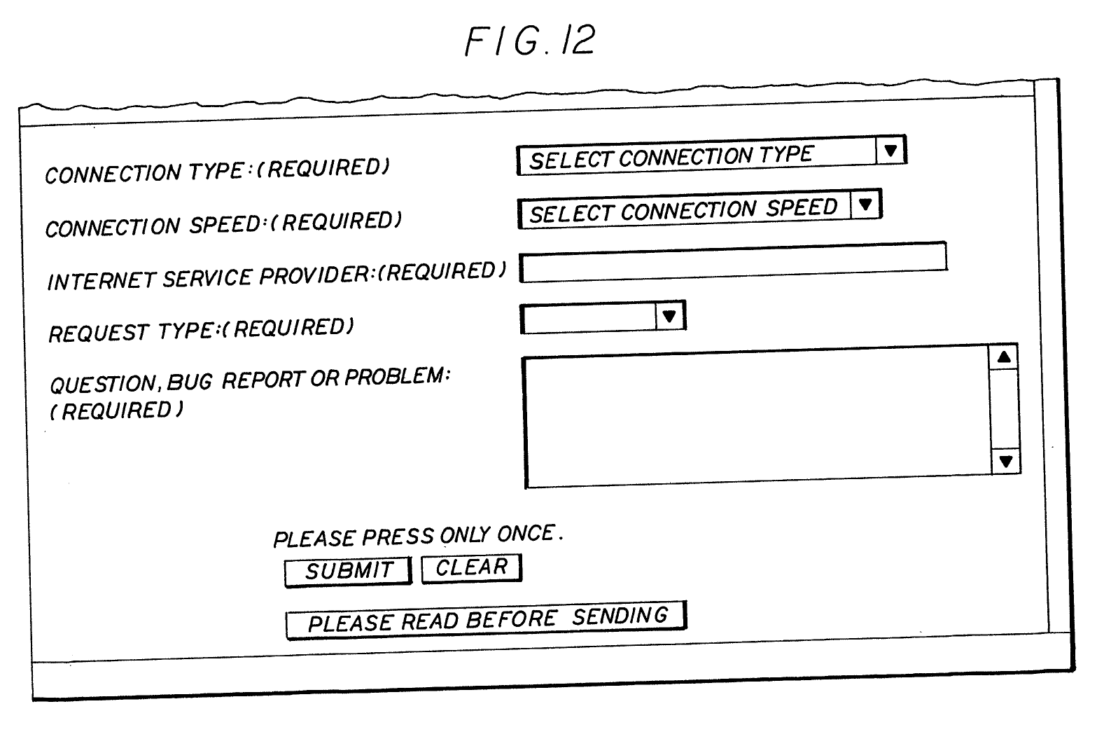

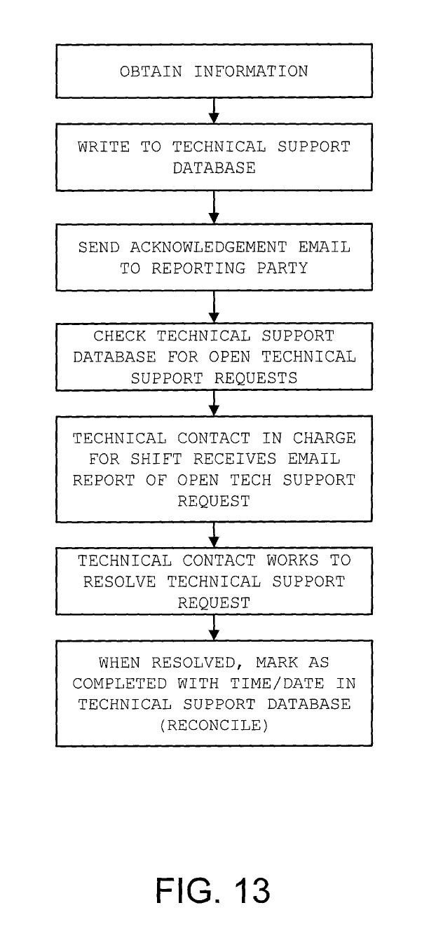

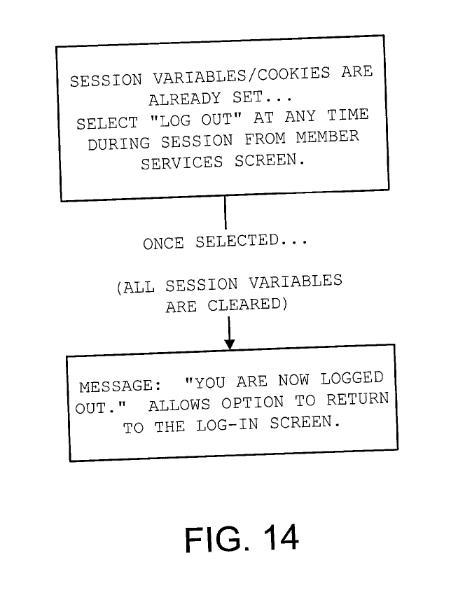

The Member Services menu further includes an option to cancel the service and the program as disclosed in FIG. 10 with the associated computer flow chart illustrated in FIG. 11. Note that confirmation is provided. The Member Services menu also includes an option to contact Technical Support as indicated in Technical Support menu (FIG. 12) and the Computer flow chart as illustrated in FIG. 13. The individual is provided with capability to indicated the type of problem and provide details thereof. The provider can then analyze the problem and correct it and contacts the individual by Email. Of course, a Log out Option is provided and is illustrated in the computer flow chart provided in FIG. 14.

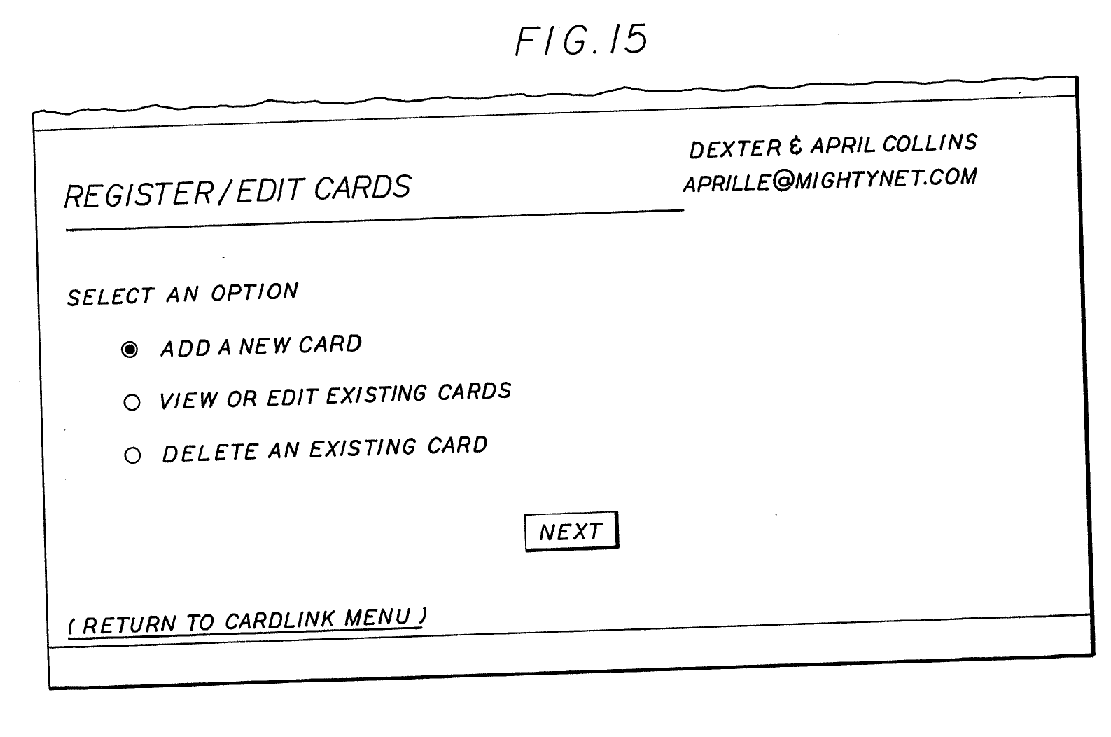

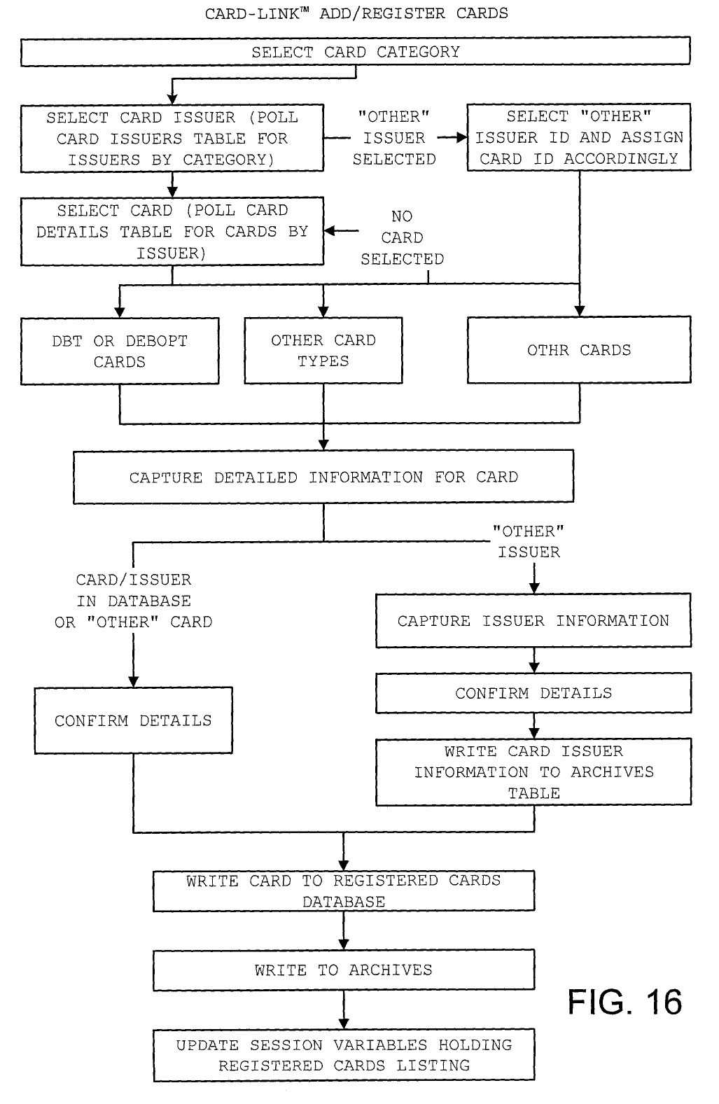

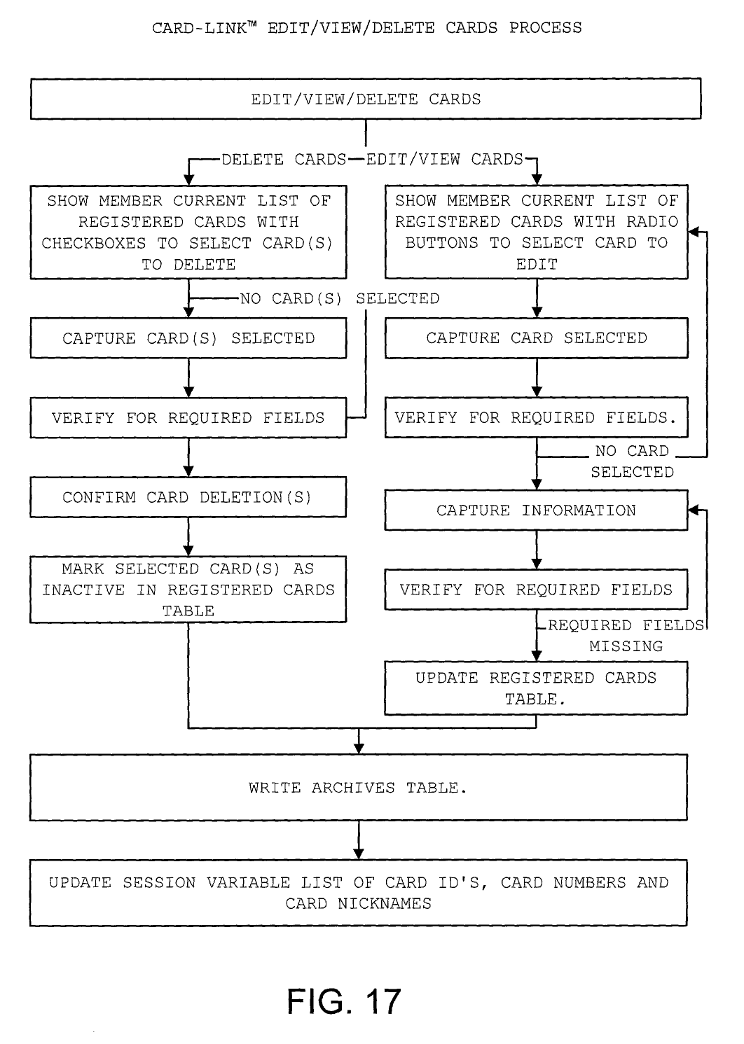

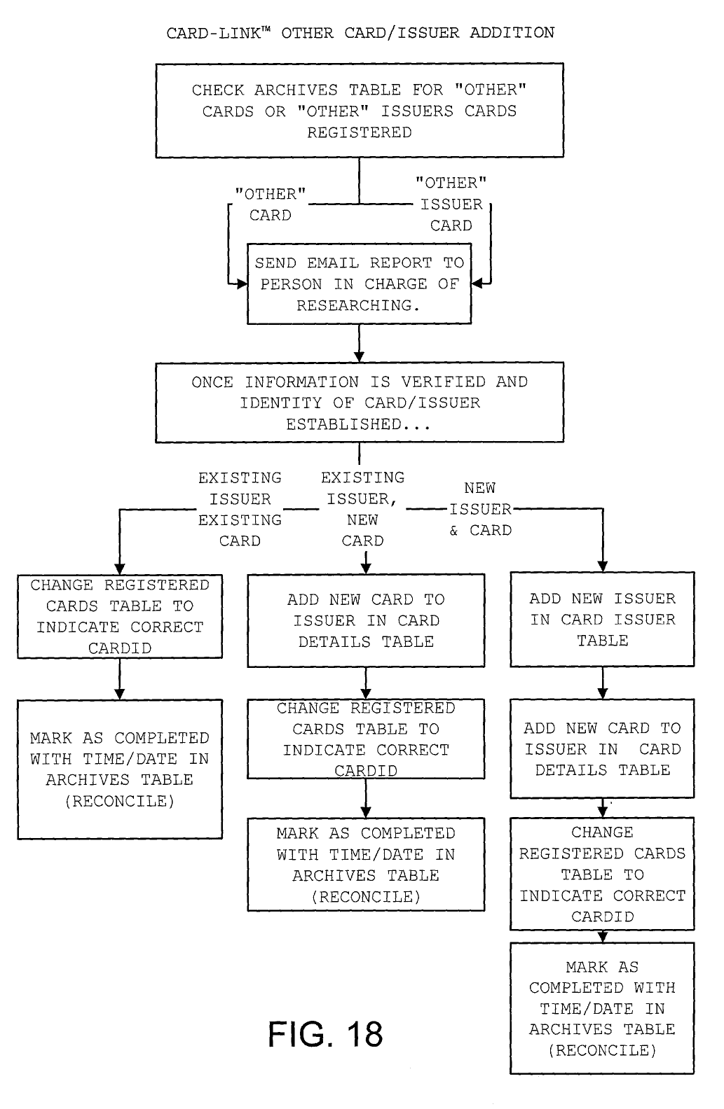

Still referring to the Member Services menu in FIG. 8 and additionally, to the Register/Edit Cards menu in FIG. 15, the flow chart for the computer program to add/register cards is illustrated in FIG. 16, while the edit/view/delete computer flow chart is illustrated in FIG. 17. Thus new cards can be added, the existing cards can be viewed and edited, and cards can be deleted. The individual is prompted to select a category of card to be added: bank, retail, membership or other. The individual is then prompted to select the card issuer from a list of cards within the program directory, or enter the name if the card is not found on the list. If issuer or card is not known, the individual will be prompted to provide issuer or card details, such as the card number, account number and sort code, etc. The individual is also prompted to enter an alternate name for the card chosen, if desired, as well as alternate billing information, if applicable. To delete cards, the individual is presented with a list of previously registered cards, and prompted to select the card(s) to be deleted. For convenience, a list is provided of the most prominent issuers and cards. If not in the list in the program directory, the individual may enter information relevant to the new card (noted as “other cards” in the flow chart in FIG. 18)

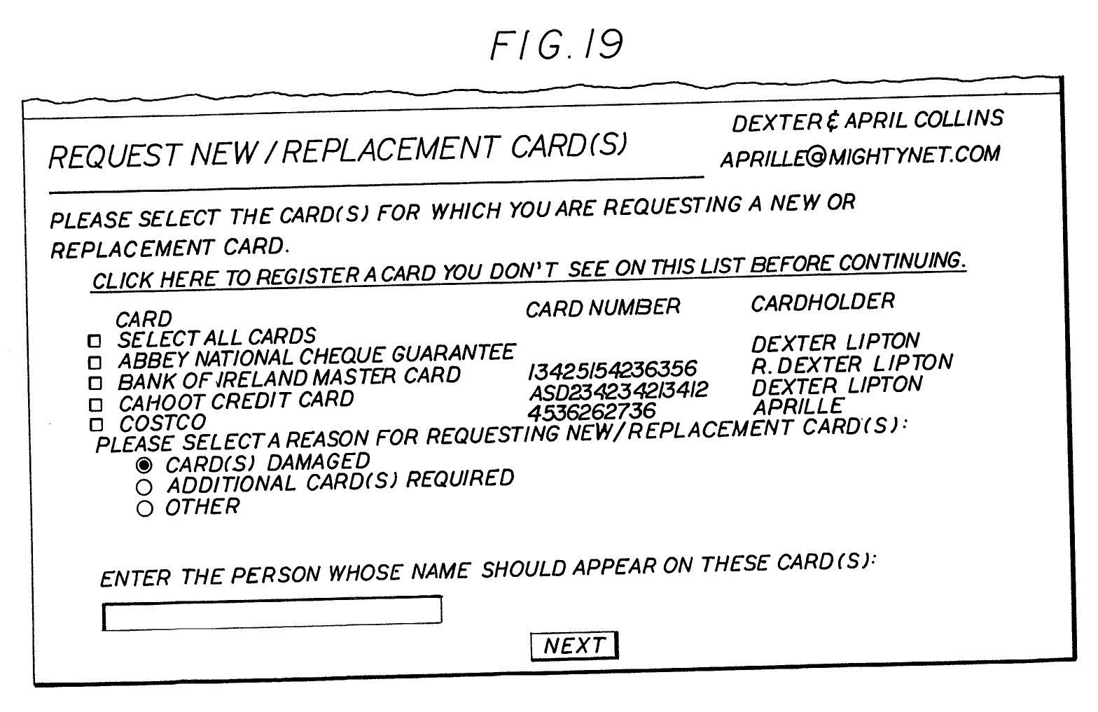

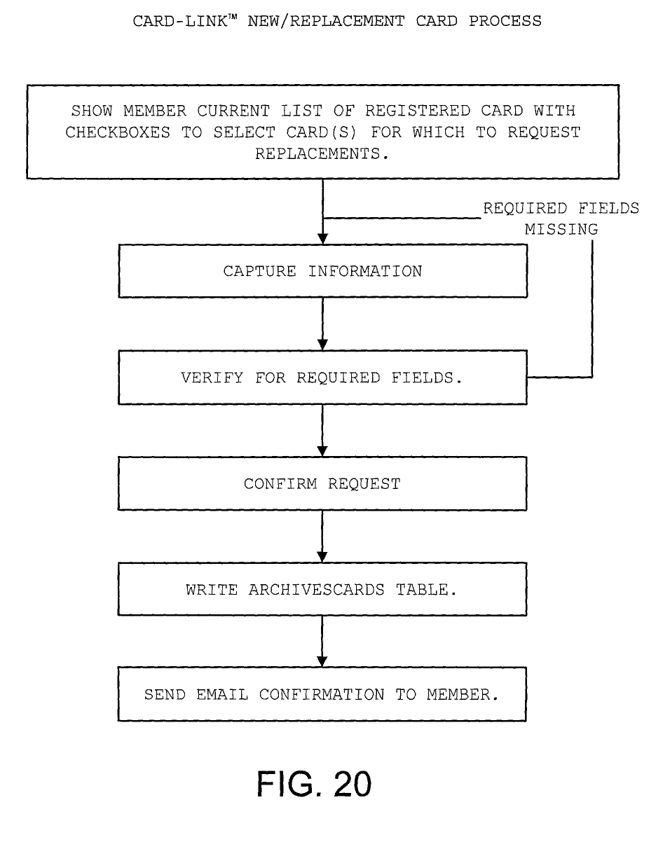

Referring to FIG. 8 and additionally to FIGS. 19, which is the Request New/Replacement Option menu screen for cards that are listed on the menu and to FIG. 20, which is flow chart of a computer program therefore, reasons for requesting the new/replacement cards can be entered, as well as the name of the individual that should appear on the card. Confirmation is provided to the individual card user.

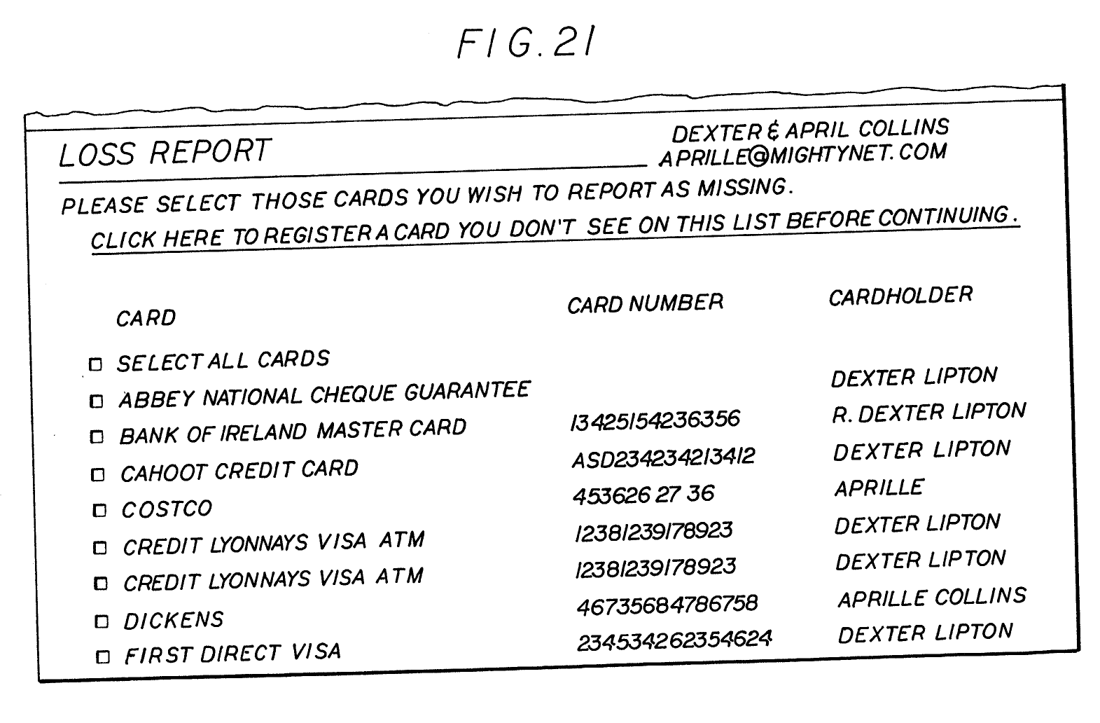

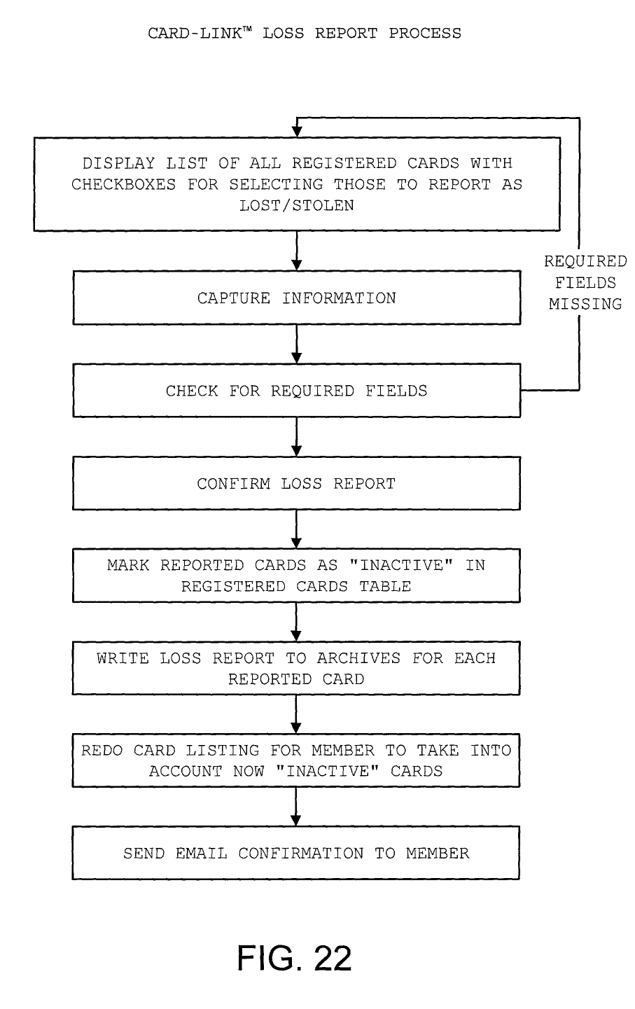

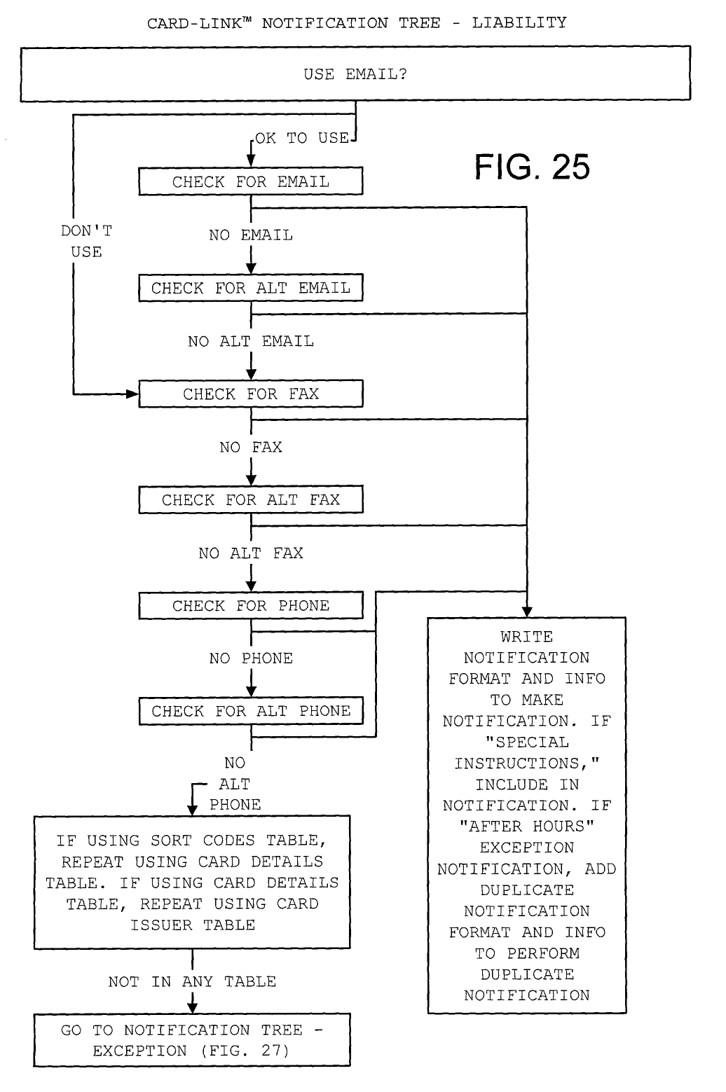

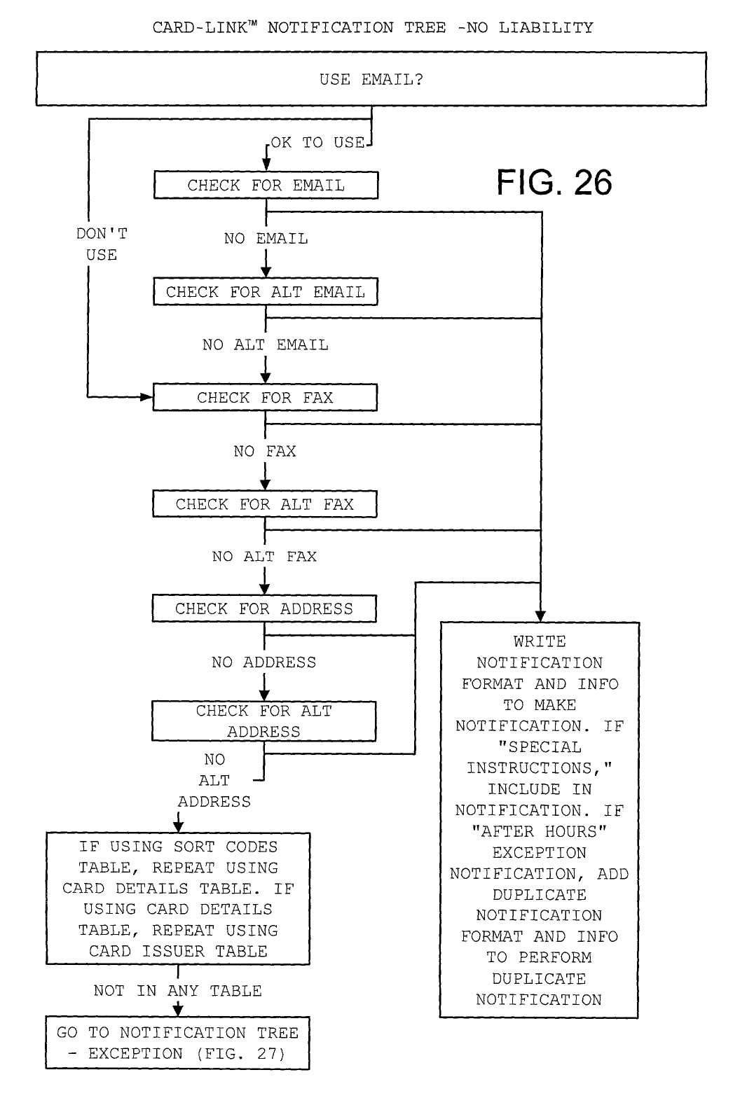

Still referring to FIG. 8 and to FIG. 21, which is the Lost Report Option menu and additionally to the flow charts for the computer program illustrated in FIGS. 22 to 27, after selecting the reporting option on the Member Services menu screen, the Reporting Option menu screen, FIG. 21, appears. The individual is prompted to select the card(s) that are missing, after first adding any missing cards to the list of registered cards. In subsequent screens, the individual is also prompted to provide details concerning the loss, then submits a lost report. Details include:

1. Whether the cards are lost or stolen.

2. Where the loss occurred.

3. Date loss occurred (or date user discovered cards missing).

4. Temporary phone numbers where user can be reached during next 48 hours.

5. Police report number, if any.

6. Notes about loss.

7. Whether or not replacement cards are required.

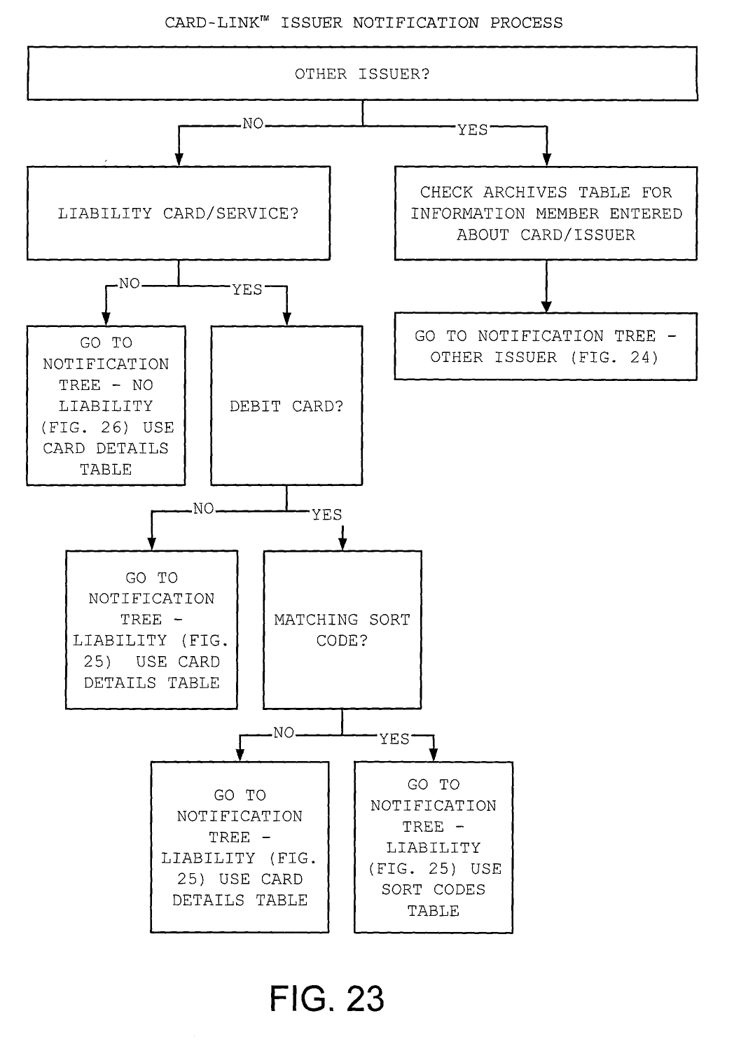

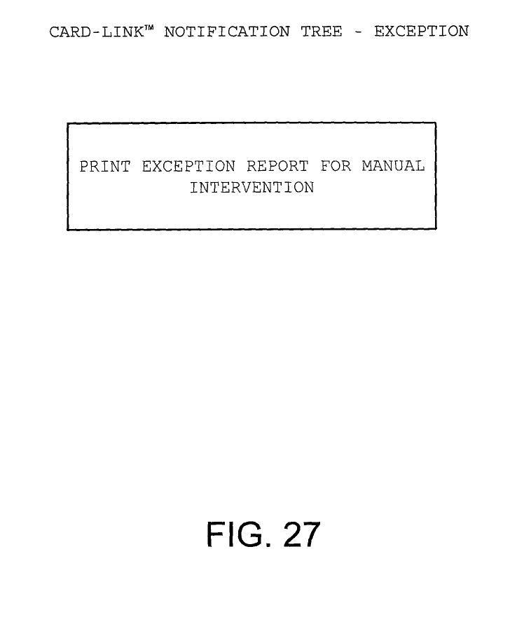

The flow chart presented in FIG. 22 covers a computer program for recording and initial processing of the card holder report, with confirmation back to the individual. FIGS. 23-27 are flowcharts that determine how the card issuer is to be notified. If the card issuer are in the program directory, a determination is made as to whether the card user has liability (such as a credit card with can be fraudulently used). If there is no liability, the program moves to flowchart 26 and if liability attaches then the program moves to flowchart 25. In both cases all avenues of communication with the card issuer will be tried. If all attempts are unsuccessful, then an exception report (FIG. 27) is prepared for the Card Service Organization to “manually” handle.

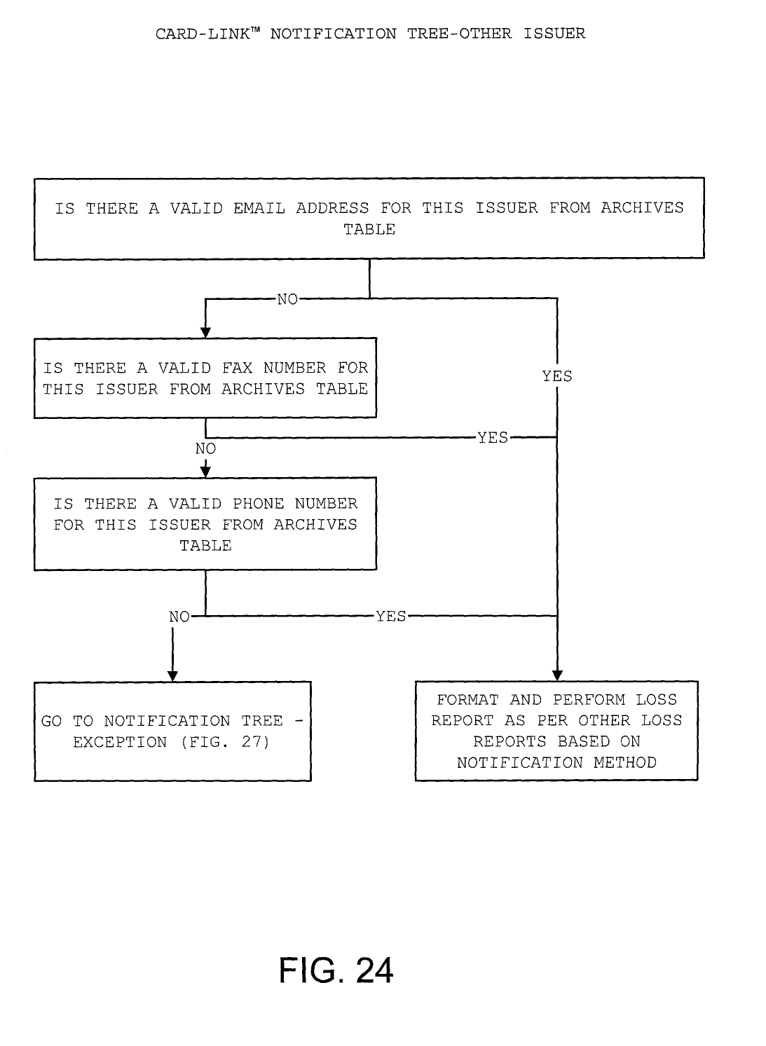

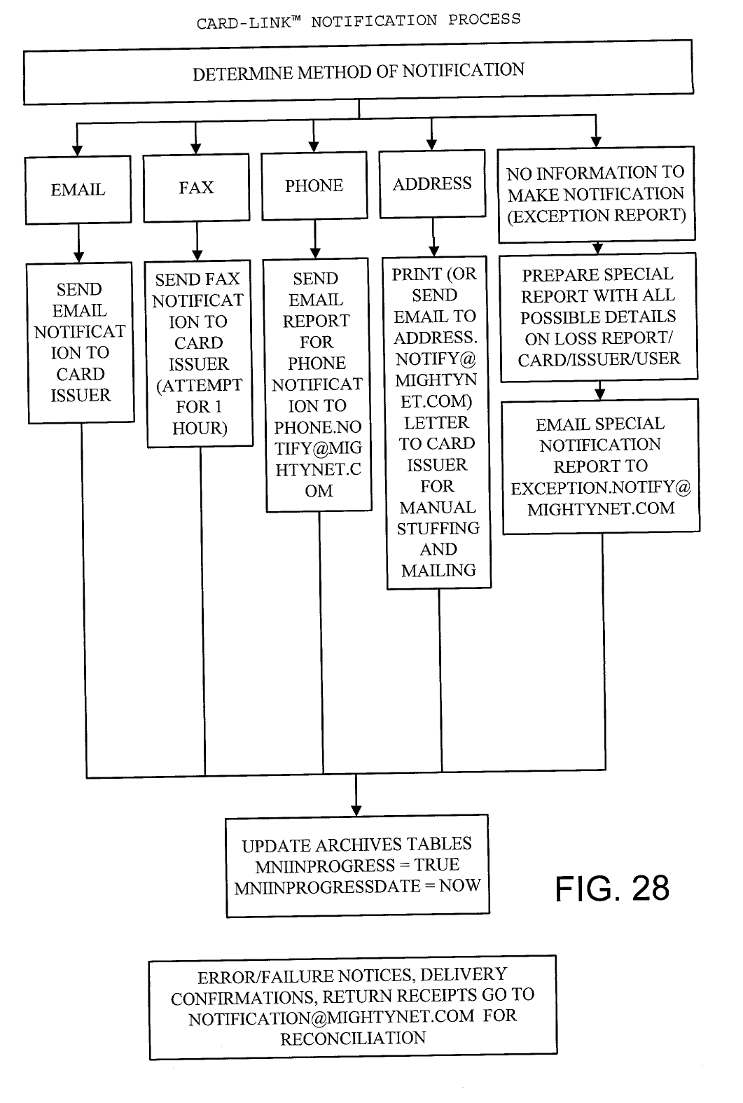

Referring back to FIG. 23, if the card is from an “other issuer”, or in other words not in the program directory, then the program transfers to the program set forth in the flowchart in FIG. 24. Again, if automated contact can not be made, then an exception report (FIG. 27) is prepared for the Card Service Organization to “manually” handle. In FIG. 28, a flow chart is presented wherein the Card Management Organization personnel can monitor the progress of the reporting lost cards to the card issuer.

In all cases, the individual receives an e-mail confirmation, and periodic e-mail reminders to update their card list. In addition, the service is archived for a minimum of two years.

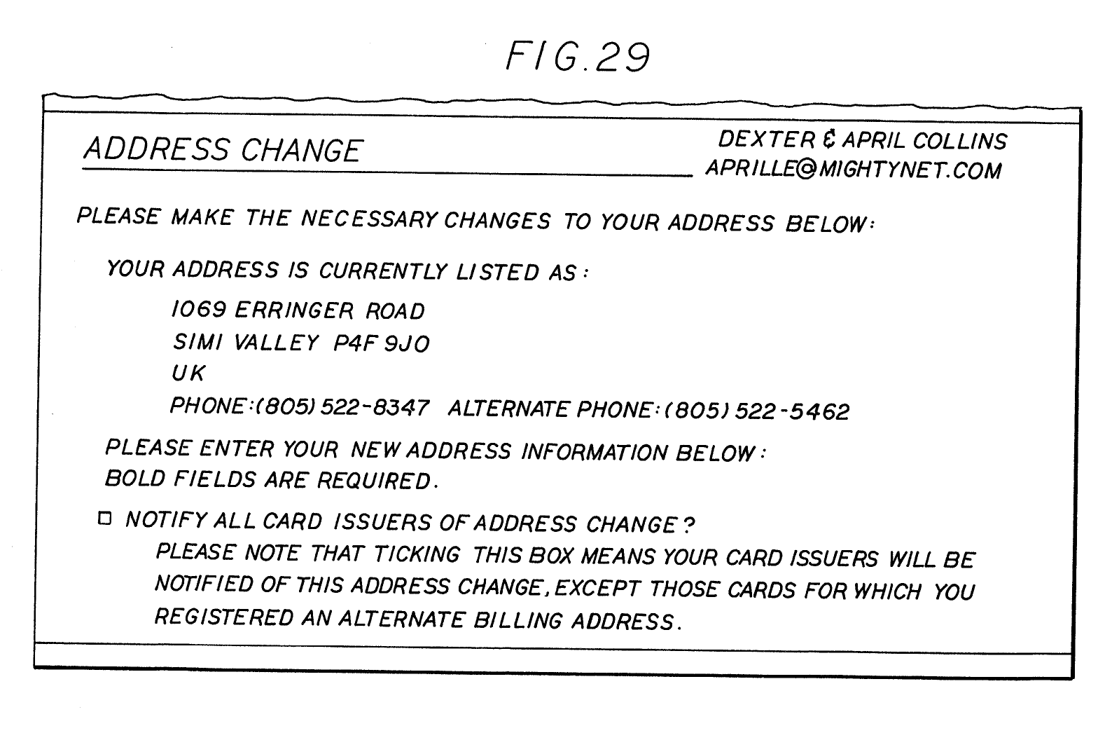

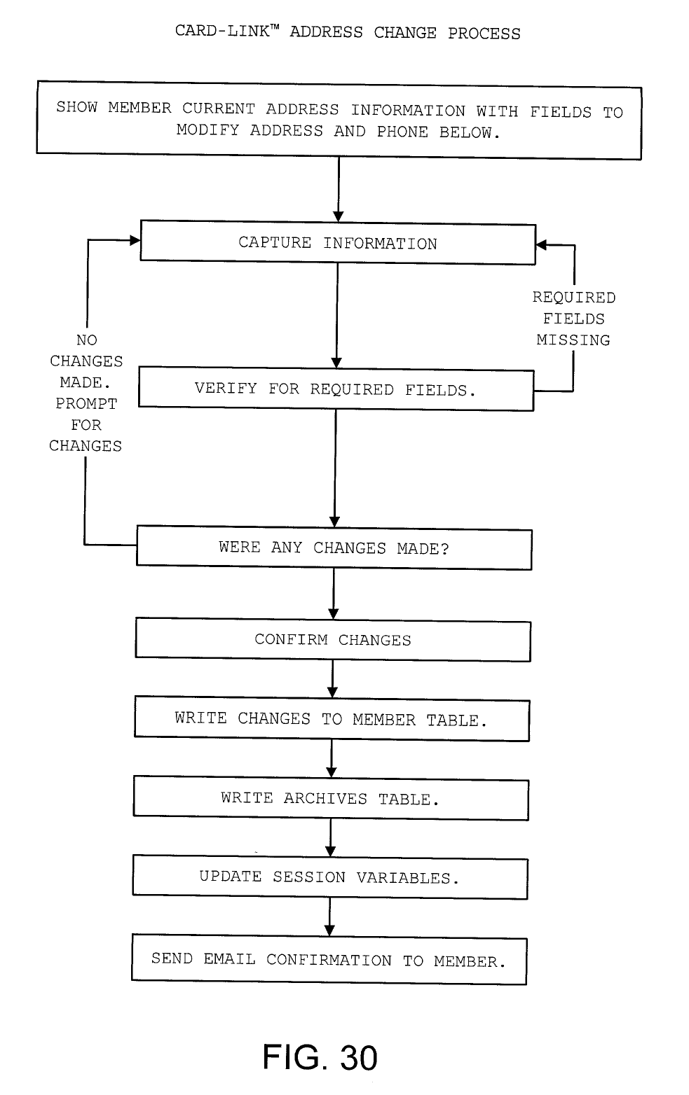

Referring to FIG. 8 and to FIG. 29, which discloses a Change of Address Menu screen and FIG. 30, which is the flow chart for the computer program to achieve a change of address, the individual is prompted to provide the new address, and indicate if all issuers are to be notified. Notification made via e-mail, fax or letter, if applicable. The individual receives an e-mail confirmation and periodic e-mail reminders to update the card list. The service is archived for a minimum of two years.

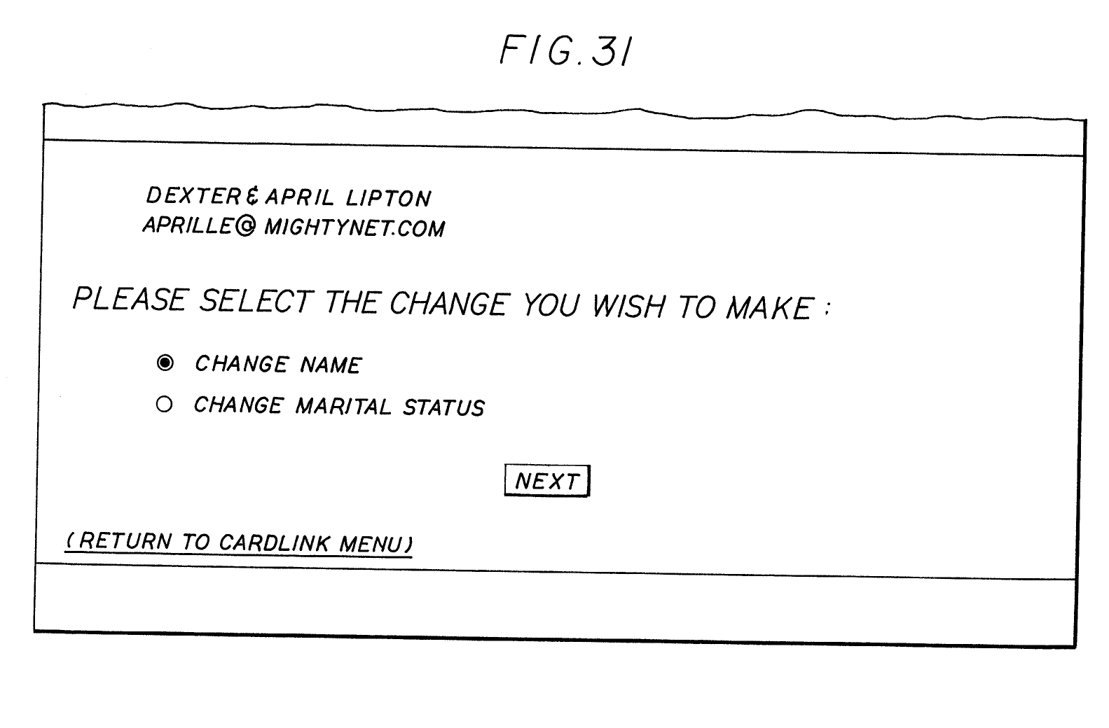

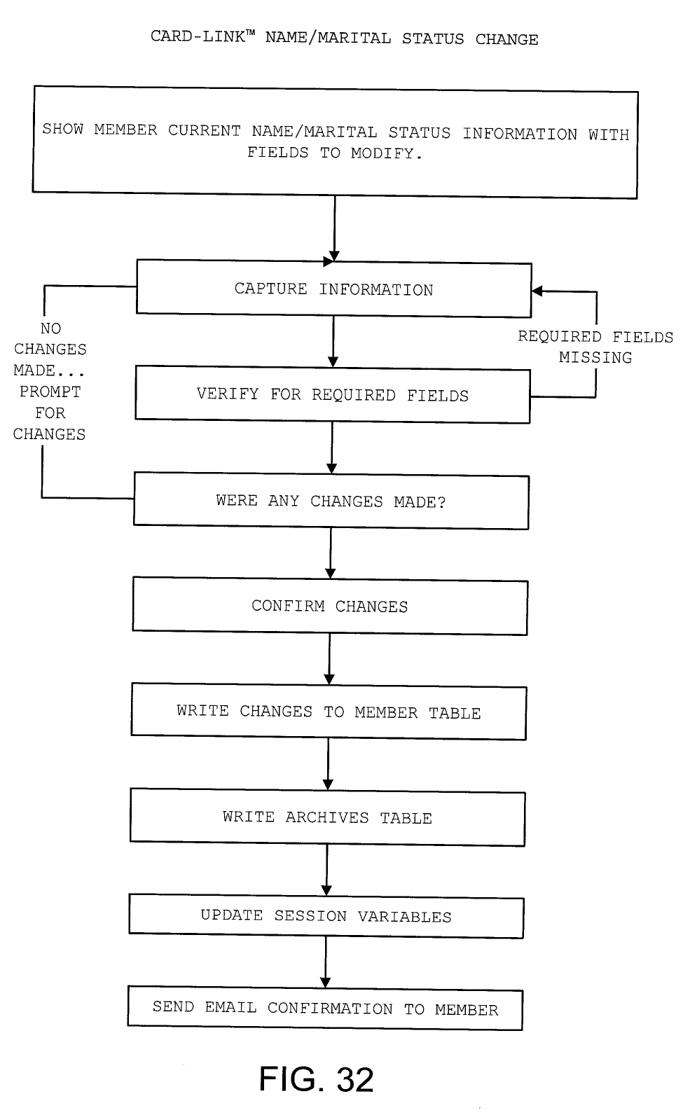

The individual user can request a name change or change in marital status. Again referring to FIG. 8 and, additionally to FIG. 31 which is a screen that prompts the individual to select the change and FIG. 32 which is the flow chart for the computer program therefore, the individual can indicate the changes and can provide details. Notifications are made via e-mail, fax or letter and the individual receives an e-mail confirmation and periodic e-mail reminders to update card list. The service is archived for a minimum of two years.

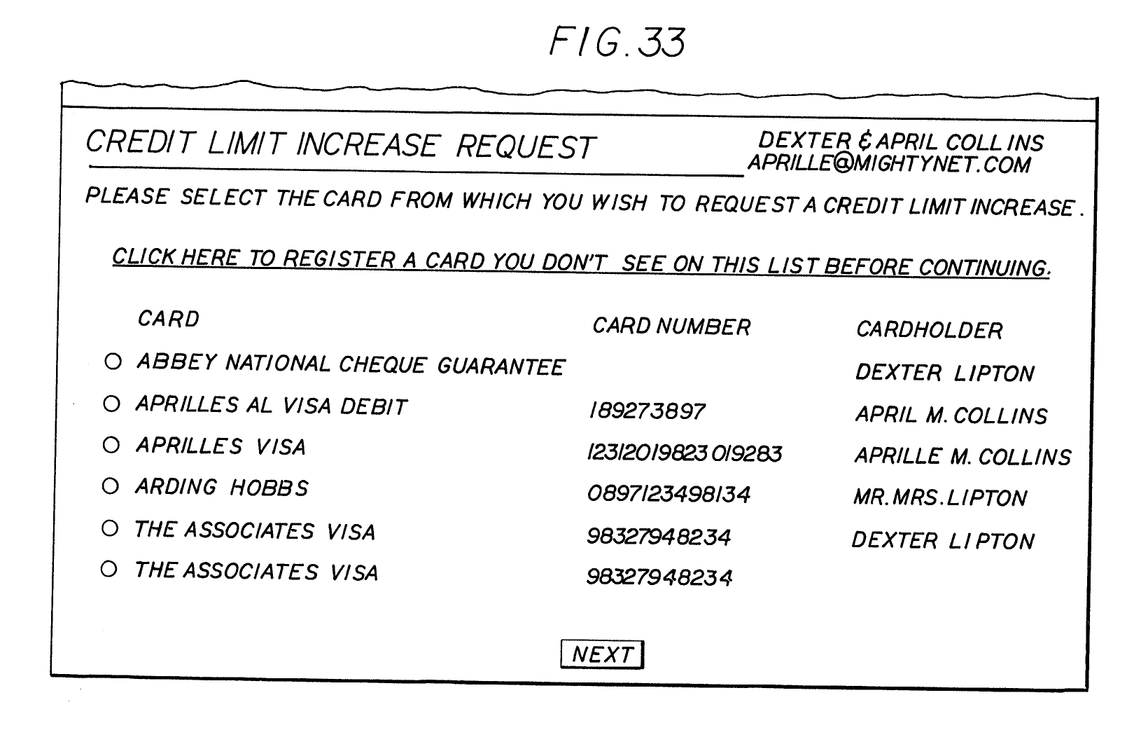

The individual user can request that a card issuer increase credit amount. Again referring to FIG. 8 and, additionally to FIG. 33, which is a screen for prompting the individual to select the card and 34, the flow chart for the computer program therefore, the individual is prompted to select the card for which a credit increase is desired. Notifications are made via e-mail, fax or letter and the individual receives an e-mail confirmation and periodic e-mail reminders to update card list. The service is archived for a minimum of two years.

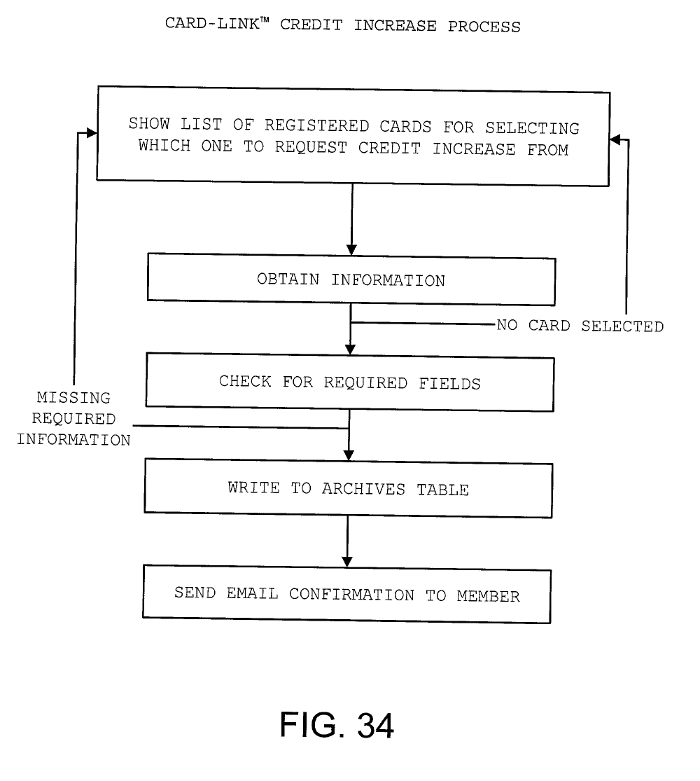

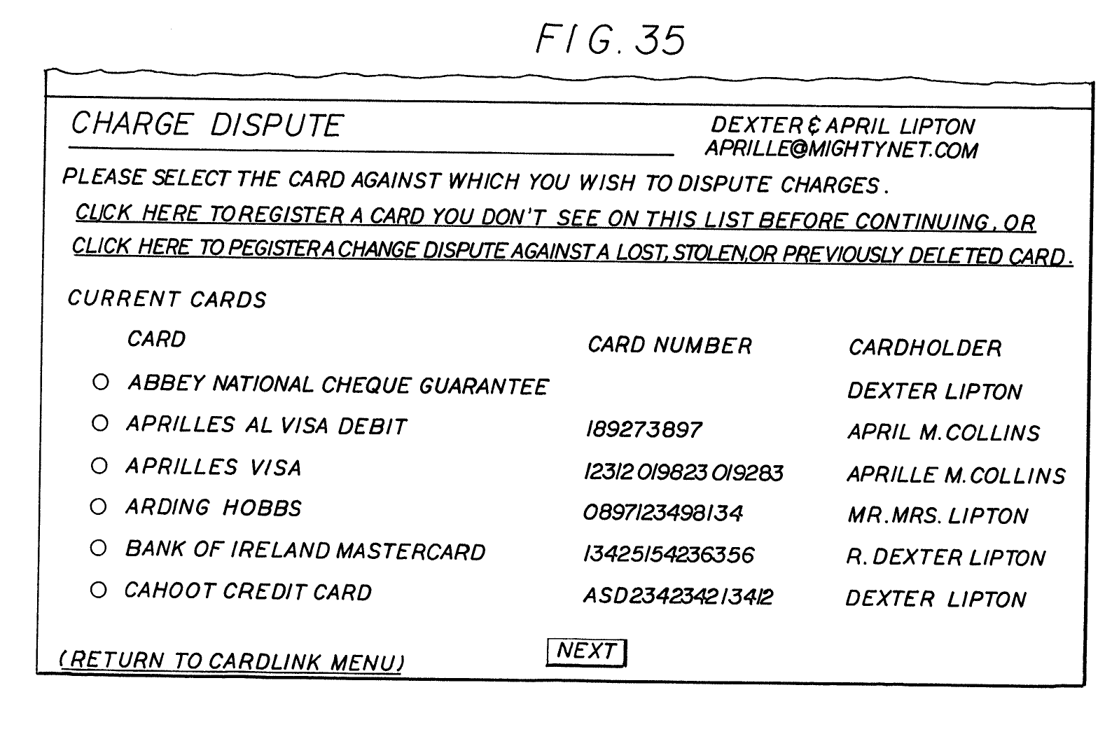

From the Member services menu (FIG. 8) the individual user can notify the card issuer of a credit card charge dispute. Referring to FIG. 34, which is a screen that allows the individual to select the card, and to FIG. 35, which is a flow chart for the associated computer program thereto, the individual selects the card who's billing is in dispute and provides information on the particular charge in dispute. The card issuer is notified and the individual is informed by Email when the card issuer is notified. The service is archived for a minimum of two years.

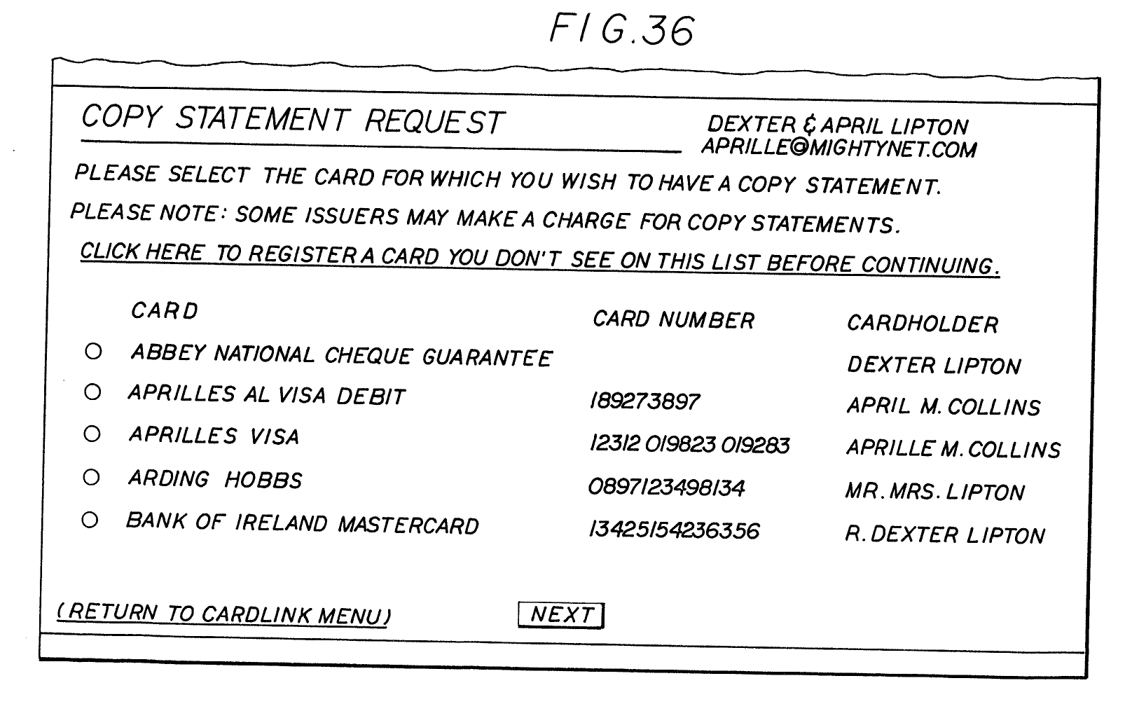

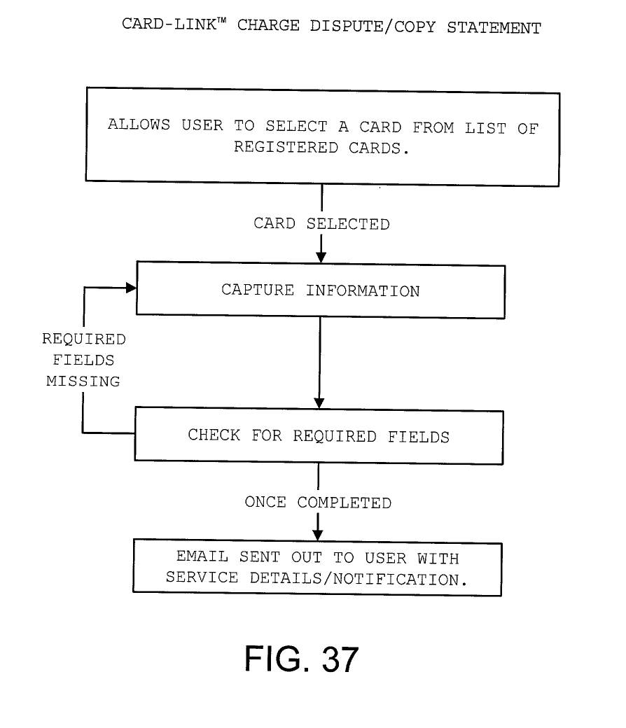

Still referring to FIG. 8, the individual can bring up a record of all transactions over any given period of time up to two years and request a copy thereof. The Screen is illustrated in FIG. 36 while the flow chart for the associated computer program is provided in FIG. 37.

In accordance with a further aspect of the present invention, the card management system includes a telephonic user interface, which allows a user to communicate with the card management system via telephone 62 rather than via the computer network. In a preferred alternative embodiment, the telephonic user interface includes a conventional voice recognition/response system 63, as illustrated in FIG. 1. The telephonic user interface allows a user to use their voice and/or telephone keypad to select card management services and input data to the card management system. Instructions and confirmation information is output aurally to the user through the telephone speaker. All of the services accessible via the computer network are also accessible via the telephonic user interface. This allows a user to use the card management system when access to the computer network is unavailable or inconvenient (e.g., when traveling without a laptop computer).

While the invention has been described with reference to a particular embodiment, it should be understood that the embodiment is merely illustrative, as there are numerous variations and modifications, which may be made by those skilled in the art. Thus, the invention is to be construed as being limited only by the spirit and scope of the appended claims.

INDUSTRIAL APPLICABILITY

The invention has applicability to the Internet business industry as well as the credit card industry.

1. A method of on-line card management comprising:
accessing a computer system in a computer network;
selecting at least one of a plurality of card management services provided by said computer system; and
inputting data associated with the selected card management service.

2. A method according to claim 1, wherein said plurality of card management services includes registering at least one card by inputting associated card data.

3. An on-line card management system comprising:
a computer system accessible via a computer network, said computer system including:
selection means for selecting at least one of a plurality of card management services; and
input means for inputting data associated with a selected card management service.

4. An on-line card management system according to claim 3, wherein said plurality of card management services includes registering at least one card by inputting associated card data.

5. An on-line card management system according to claim 3, wherein said computer system includes a telephonic user interface.

6. An on-line card management system according to claim 5, wherein said telephonic user interface includes a voice response system.

7. A method of on-line card management, wherein the card is issued to a card user by a issuing organization, the method comprising:
accessing a card management computer system in a computer network; and
selecting at least one of a plurality of card management services provided by said computer system; and inputting data associated with the selected card management service; and
providing said associated data to the issuing organization.

8. The method as set forth in claim 7 wherein said plurality of card management services includes registering at least one card by inputting associated card data.

9. The method as set forth in claim 7 wherein card management services further includes card management services selected from the group consisting of: change of address, request for a new card, notification of a billing dispute, request for a copy of a bill, a change in martial status; a change in name and a request for an increase in credit line.

10. The method as set forth in claim 7, or 8, or 9, further including the step of maintaining a record of the associated data.

11. The method as set forth in claim 10 including the step of informing the card user that the card issuing organization has been provided the associated data.

12. A system for on-line card management, wherein the card is issued to a card user by a issuing organization, the system comprising:
means for accessing a card management computer system in a computer network;
means for selecting at least one of a plurality of card management services provided by said computer system; and inputting data associated with the selected card management service; and
means for providing said associated data to the issuing organization.

13. The on-line card management system as set forth in claim 12 wherein said plurality of card management services includes registering at least one card by inputting associated card data.

14. The on-line card management system as set forth in claim 13 wherein said card management services further includes card management services selected from the group consisting of: change of address, request for a new card, notification of a billing dispute, request for a copy of a bill, a change in martial status, change in name and a request for an increase in credit line.

15. The on-line card management system as set forth in claim 12, or 13, or 14, further including means for maintaining a record of the associated data.

16. The on-line card management system as set forth in claim 15 including means for informing the card user that the card issuing organization has been provided the associated data.

17. The on-line card management system of claim 16 wherein said computer system includes a telephonic user interface.
